(19) United States
(12) Patent Application Publication
(10) Pub. No.: US 2025/0136100 A1
(43) Pub. Date: May 1, 2025

(54) METHOD AND COMPUTING DEVICE FOR PREVENTING COLLISION OF AUTONOMOUS VEHICLE AND RECORDING MEDIUM HAVING PROGRAM FOR THE SAME RECORDED THEREON

(71) Applicant: RideFlux Inc., Jeju-si (KR)

(72) Inventors: Seunghyoun LEE, Jeju-si (KR); Jihun KIM, Jeju-si (KR); Jiwoong KIM, Seoul (KR); Junghee PARK, Jeju-si (KR); Ho YUN, Jeju-si (KR)

(73) Assignee: RideFlux Inc., Jeju-si (KR)

(21) Appl. No.: 18/909,454

(22) Filed: Oct. 8, 2024

(30) Foreign Application Priority Data
Oct. 31, 2023 (KR) 10-2023-0147834

(51) Int. Cl. B60W 30/09; B60W 30/095; B60W 60/00

(52) U.S. Cl. CPC B60W 30/09; B60W 30/0953; B60W 30/0956; B60W 60/0015

(57) ABSTRACT

A method and device for preventing a collision of an autonomous vehicle and a recording medium having a program for the same recorded thereon are provided. The method of preventing a collision of an autonomous vehicle according to various embodiments of the present invention that is performed by a computing device may include selecting a collision detection target from among a plurality of road users positioned near the autonomous vehicle and determining a collision possibility between the autonomous vehicle and the selected collision detection target.

### CROSS-REFERENCE TO RELATED APPLICATION

This application claims priority to and the benefit of Korean Patent Application No. 10-2023-0147834, filed on Oct. 31, 2023, the disclosure of which is incorporated herein by reference in its entirety.

### BACKGROUND

### 1. Field of the Invention

Various embodiments of the present invention relate to a method and device for preventing a collision of an autonomous vehicle and a recording medium having a program for the same recorded thereon.

### 2. Discussion of Related Art

For the convenience of users driving vehicles, there is a trend toward installing various sensors, electronic devices (e.g., advanced driver assistance systems (ADASs)), and the like, and in particular, technology development for autonomous driving systems that recognize the surrounding environment without driver intervention and allow vehicles to automatically drive themselves to a given destination according to the recognized surrounding environment is being actively underway.

An autonomous vehicle refers to a vehicle equipped with an autonomous driving system function that recognizes the surrounding environment without driver intervention and automatically drives by itself to a given destination according to the recognized surrounding environment, and the autonomous driving system function refers to performing localization, recognition, prediction, planning, and control for autonomous driving.

The autonomous driving system detects objects positioned around an autonomous vehicle by processing sensor data acquired through various sensors (e.g., cameras, radars, lidar sensors, and the like) through a cognitive process, and receives cognitive results (e.g., information such as a position, attitude, and speed of an object) derived from performing the cognitive process and establishes a driving plan such as a route, a speed, and the like, of the autonomous vehicle through a determination process.

### SUMMARY OF THE INVENTION

Since an autonomous driving system dynamically drives by making its own determination without driver intervention, there is a problem that there is a high possibility of collision accidents between an autonomous vehicle and adjacent road users (e.g., vehicles, people, other structures, or the like), and accordingly, in autonomous driving systems in the related art, in order to prevent collision accidents involving autonomous vehicles, a collision detection region of a certain size is set around an autonomous vehicle, and a collision possibility between road users and the autonomous vehicle within the collision detection region is continuously determined.

Meanwhile, since collision detection methods in autonomous driving systems in the related art are performed on all road users positioned near an autonomous vehicle and are typically performed at very short intervals (e.g., 0.1 seconds), as the number of road users near the autonomous vehicle increases, computational resources required to determine the collision possibility increase, and accordingly, there is a problem that the increase adversely affects the real-time performance of a collision possibility determination operation.

Therefore, the present invention has been made to solve the problems in collision detection methods in autonomous driving systems in the related art, and is directed to providing a method and device for preventing a collision of an autonomous vehicle capable of drastically reducing resources required for computational work for determining a collision possibility by selecting road users of concern from among road users positioned near an autonomous vehicle and selectively determining the collision possibility only for the road users of concern, more efficiently and quickly performing a collision possibility determination operation through the reduction, and effectively preventing a collision of the autonomous vehicle based on the efficient and quick operation performance, and a recording medium having a program for the same recorded thereon.

Problems to be solved by the present invention are not limited to those mentioned above, and other problems not mentioned will be clearly understood by those of ordinary skill in the art from the following description.

According to an aspect of the present invention, there is provided a method of preventing a collision of an autonomous vehicle performed by a computing device, the method including selecting a collision detection target from among a plurality of road users positioned near the autonomous vehicle and determining a collision possibility between the autonomous vehicle and the selected collision detection target.

In various embodiments, the selecting of the collision detection target may include setting a first region corresponding to the autonomous vehicle based on a driving route of the autonomous vehicle, setting a plurality of second regions corresponding to the plurality of road users, respectively, based on an expected driving route for each of the plurality of road users, and selecting a second region that at least partially overlaps the set first region from among the plurality of set second regions and selecting a road user corresponding to the selected second region as the collision detection target.

In various embodiments, the driving route of the autonomous vehicle may be a route for controlling driving of the autonomous vehicle for a predetermined period of time and include a plurality of points disposed at equal intervals on the route, and the setting of the first region may include setting a first temporary region in a box shape including all of the plurality of points, setting a second temporary region by adjusting a size of the set first temporary region so that an entire shape area of the autonomous vehicle is included when the autonomous vehicle is positioned at a point corresponding to each of the plurality of points, and setting a third temporary region by increasing a size of the set second temporary region by a predetermined ratio and setting the set third temporary region as the first region corresponding to the autonomous vehicle.

In various embodiments, the driving route of the autonomous vehicle may be a route for controlling driving of the autonomous vehicle for a predetermined period of time in the future and expressed as a set of a plurality of points disposed at equal intervals on the route, and the setting of the first region may include generating a plurality of point groups by classifying the plurality of points according to a preset criterion, setting a plurality of first unit regions corresponding to the plurality of generated point groups, respectively, and setting a first region including the plurality of set first unit regions.

In various embodiments, the generating of the plurality of point groups may include grouping points disposed between a first point and a second point after the first point among the plurality of points into one point group that is the same as the first point when an offset between the first point and the second point is equal to or greater than a threshold value, wherein the offset is a deviation to the left or right based on a driving direction of the autonomous vehicle and grouping points disposed between the second point and a third point after the second point into one point group that is the same as the second point when an offset between the second point and the third point is equal to or greater than the threshold value.

In various embodiments, the expected driving route for each of the plurality of road users may be a route through which each of the plurality of road users is expected to travel for a predetermined period of time in the future and expressed as a set of a plurality of points disposed at equal intervals on the expected route, and the setting of the plurality of second regions may include setting a first temporary region in a box shape including all of the plurality of points disposed on the expected driving route for one of the plurality of road users, setting a second temporary region by adjusting a size of the set first temporary region so that an entire shape area of the one of the road users is included when the one of the road users is positioned at a point corresponding to each of the plurality of points, and setting a third temporary region by increasing a size of the set second temporary region at a predetermined ratio and setting the set third temporary region as the second region corresponding to the one of the road users.

In various embodiments, the expected driving route for each of the plurality of road users may be a route through which each of the plurality of road users is expected to travel for a predetermined period of time in the future and expressed as a set of a plurality of points disposed at equal intervals on the expected route, and the setting of the plurality of second regions may include generating a plurality of point groups by classifying a plurality of points disposed on the expected driving route for one of the plurality of road users according to a preset criterion, setting a plurality of second unit regions corresponding to the plurality of generated point groups, respectively, and setting the second region including the plurality of set second unit regions.

In various embodiments, the determining of the collision possibility may include setting a collision detection region for each of the autonomous vehicle and the selected collision detection target based on states of the autonomous vehicle and the selected collision detection target and determining the collision possibility between the autonomous vehicle and the selected collision detection target using the collision detection region set for the autonomous vehicle and the collision detection region set for the selected collision detection target, and the collision detection region set for each of the autonomous vehicle and the selected collision detection target may include a first collision detection region and a second collision detection region and be expressed as a set of a plurality of circular regions.

In various embodiments, the determining of the collision possibility may include determining a collision possibility at a present point in time and a collision possibility at a future point in time for each of the autonomous vehicle and the selected collision detection target, wherein the future point in time is determined based on a driving route and a speed profile of the autonomous vehicle and an expected driving route and an expected speed profile of the selected collision detection target.

According to another aspect of the present invention, there is provided a computing device that performs a method of preventing a collision of an autonomous vehicle, including a processor, a network interface, a memory, and a computer program that is loaded into the memory and is executed by the processor, and the computer program includes instructions for selecting a collision detection target from among a plurality of road users positioned near the autonomous vehicle and instructions for determining a collision possibility between the autonomous vehicle and the selected collision detection target.

According to still another aspect of the present invention, there is provided a computer program stored in a computer readable recording medium that is coupled to a computing device for executing a method of preventing a collision of an autonomous vehicle recorded thereon, the method including selecting a collision detection target from among a plurality of road users positioned near the autonomous vehicle and determining a collision possibility between the autonomous vehicle and the selected collision detection target.

Other details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating an autonomous driving system according to one embodiment of the present invention;

FIG. 2 is a hardware configuration diagram of a computing device that performs a collision prevention method of an autonomous vehicle according to another embodiment of the present invention;

FIG. 3 is a flowchart of a method of preventing a collision of an autonomous vehicle according to still another embodiment of the present invention;

FIG. 4 is a flowchart for describing a method of selecting a collision detection target in various embodiments;

FIG. 5 is a view for describing a process of setting a first region corresponding to an autonomous vehicle in various embodiments;

FIG. 6 is a view for describing a process of setting a first region including a plurality of first unit regions in various embodiments;

FIG. 7 is a view for describing a process of setting a second region corresponding to a road user in various embodiments;

FIG. 8 is a view for describing a process of selecting a collision detection target depending on whether an overlapping region of the first region exists in various embodiments;

FIG. 9 is a flowchart for describing a method of determining a collision possibility between an autonomous vehicle and a collision detection target in various embodiments;

FIGS. 10A and 10B are views illustrating collision detection regions set in an autonomous vehicle in various embodiments;

FIG. 11 is a diagram illustrating a form in which a plurality of second collision detection regions having different sizes are formed in an autonomous vehicle in various embodiments;

FIGS. 12A and 12B are views illustrating a configuration of changing the size of a collision detection region in response to a change in the speed of an autonomous vehicle, in various embodiments;

FIGS. 13A and 13B are views illustrating a configuration of changing an interval between a plurality of detection regions included in the collision detection region in response to a change in the speed of the autonomous vehicle, in various embodiments;

FIG. 14 is a view illustrating a configuration of adding a detection region in response to the change in the speed of the autonomous vehicle, in various embodiments;

FIG. 15 is a view for describing the process for determining the collision possibility between the autonomous vehicle and the collision detection target in various embodiments; and

FIGS. 16A to 16D are views for describing a process of determining a collision state according to the size of the overlap between collision detection regions of the autonomous vehicle and the collision detection target in various embodiments.

### DETAILED DESCRIPTION OF EXEMPLARY EMBODIMENTS

Advantages and features of the present invention, and methods of achieving the advantages and features will be clarified with reference to embodiments described below in detail together with the accompanying drawings. However, the present invention is not limited to the embodiments disclosed below, and may be implemented in a variety of different forms. The present embodiments are only provided to allow disclosure of the present invention to be complete, and to completely inform those of ordinary skill in the art to which the present invention belongs of the scope of the present invention, and the present invention is merely defined by scope of the claims.

The terms used in the present specification are for the purpose of describing the embodiments only and are not intended to limit the present invention. In the present specification, the singular forms are intended to include the plural forms as well, unless the context clearly indicates otherwise. It will be further understood that the terms “comprises” and/or “comprising”, when used in this specification, do not preclude the presence or addition of one or more other elements in addition to the mentioned element. Like reference numerals refer to like elements throughout the specification, and “and/or” includes each of the referenced elements and all combinations of one or more of the referenced elements. Although “first,” “second,” etc. are used to describe various components, the components are of course not limited by the terms. The terms are merely used to distinguish one component from another. Therefore, it goes without saying that a first component mentioned below may also be a second component within the technical spirit of the present invention.

Unless otherwise defined, all terms (including technical and scientific terms) used herein have the same meanings as commonly understood by those of ordinary skill in the art to which the present invention pertains. In addition, it will be further understood that terms, such as those defined in commonly used dictionaries, will not be interpreted in an idealized or overly formal sense unless expressly so defined herein.

The term “unit” or “module” used in the specification refers to a hardware component such as software, FPGA, or ASIC, and the “unit” or “module” performs certain roles. However, “unit” or “module” may not be limited to software or hardware components. “Unit” or “module” may be configured to be in an addressable storage medium, or may be configured to reproduce one or more processors. Therefore, for example, “unit” or “module” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” or “module” may be coupled with lesser numbers of components and “units” or “modules,” or may be further divided into additional components and “units” or “modules.”

Spatially relative terms such as “below,” “beneath,” “lower,” “above,” “upper,” etc. may be used to easily describe the correlation between one component and other components as shown in the drawings. Spatially relative terms should be understood as terms that include different directions of components during use or operation in addition to directions shown in the drawings. For example, when a component shown in a drawing is turned over, a component described as “below” or “beneath” another component may be placed “above” the other component. Accordingly, the illustrative term “below” may include both downward and upward directions. A component may also be oriented in other directions, and thus spatially relative terms may be interpreted according to orientation.

In the present specification, a computer refers to all types of hardware devices including at least one processor, and may be understood as encompassing software configurations that operate on a hardware device depending on the embodiment. For example, a computer may be understood to include a smartphone, a tablet PC, a desktop, a laptop, and a user client and application running on each device, but is not limited thereto.

Hereinafter, embodiments of the present invention will be described in detail with reference to the accompanying drawings.

Each step described in this specification is described as being performed by a computer, but the subject of each step is not limited thereto, and at least part of each step may be performed in a different device depending on the embodiment.

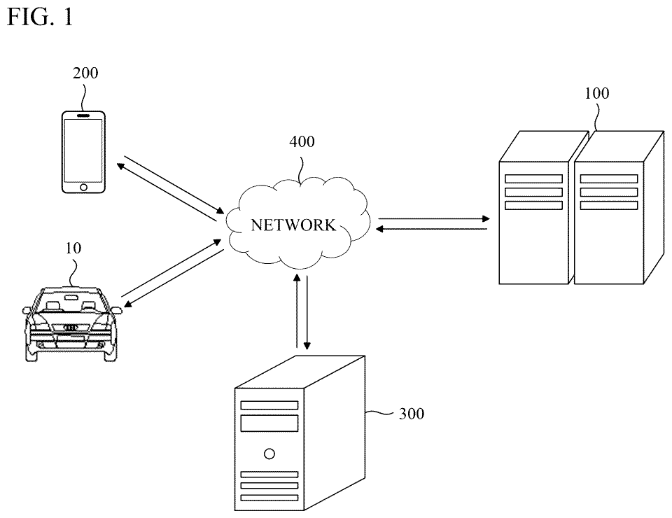

FIG. 1 is a view illustrating an autonomous driving system according to one embodiment of the present invention.

Referring to FIG. 1, an autonomous driving system according to one embodiment of the present invention may include a computing device 100, a user terminal 200, an external server 300, and a network 400.

Here, the autonomous driving system illustrated in FIG. 1 is a system according to one embodiment and components thereof are not limited to the embodiment illustrated in FIG. 1, and may be added, changed, or deleted as necessary.

In one embodiment, the computing device 100 may perform autonomous driving control on an autonomous vehicle 10. To this end, the computing device 100 may perform a localization operation, a cognitive operation, a determination operation, and a control operation.

Here, according to the autonomous driving system illustrated in FIG. 1, the computing device 100 may be separately provided outside the autonomous vehicle 10, and may determine a control command related to autonomous driving from outside the autonomous vehicle 10 and transmit the control command related to autonomous driving to the autonomous vehicle 10, thereby allowing the autonomous vehicle 10 to perform autonomous driving operations. However, without being limited thereto, the computing device 100 may correspond to one of components provided inside the autonomous vehicle 10, and may determine a control command related to autonomous driving inside the autonomous vehicle 10 and directly control components of the autonomous vehicle 10 according to the control command related to autonomous driving, thereby performing autonomous driving control on the autonomous vehicle 10. For example, the computing device 100 may be a control module that controls the operation of components included in the autonomous vehicle 10 inside the autonomous vehicle 10.

First, the localization operation performed by the computing device 100 may refer to an operation of measuring the position and attitude of the autonomous vehicle 10. For example, the computing device 100 may collect sensor data (e.g., point cloud data, image data, or the like) by scanning the surrounding environment of the autonomous vehicle 10 using sensors provided in the autonomous vehicle 10, and may calculate localization values corresponding to the position and attitude of the autonomous vehicle 10 by utilizing the collected sensor data.

Next, the cognitive operation performed by the computing device 100 may refer to an operation of detecting a road user positioned around the autonomous vehicle 10. For example, the computing device 100 may recognize a road user existing around the autonomous vehicle 10 by analyzing sensor data collected as the computing device scans an area around the autonomous vehicle 10.

Here, the road user is a user existing on the road, including, but not limited to, a vehicle, a motorcycle, a bicycle, and a pedestrian.

Next, the planning operation performed by the computing device 100 may refer to an operation capable of establishing a driving plan including the route, speed, and the like, for controlling the autonomous vehicle 10 based on localization information derived through the localization operation and cognitive information derived through the cognitive operation and deriving driving plan information including information about the established driving plan.

In various embodiments, the computing device 100 may determine a collision possibility between a plurality of road users identified through the cognitive operation and the autonomous vehicle 10. In this case, the computing device 100 may select a road user of concern from among a plurality of road users positioned near the autonomous vehicle 10 as a collision detection target, and may selectively determine the collision possibility with the autonomous vehicle 10 only for the collision detection target.

Finally, the control operation performed by the computing device 100 may refer to an operation capable of determining and generating control commands for lateral control (direction control) and longitudinal control (speed control) of the autonomous vehicle 10 based on the driving plan information and response strategy information derived through the planning operation and controlling the operation of the autonomous vehicle 10 according to the determined and generated control commands.

In various embodiments, the computing device 100 may be connected to the user terminal 200 via the network 400, and may provide various information related to autonomous driving (e.g., a high-precision map for a given area, object recognition results around the autonomous vehicle 10, control commands for autonomous driving control, and operation information about the autonomous vehicle 10 according to the control commands, or the like) to the user terminal 200.

Here, the user terminal 200 may refer to any form of entity(s) in a system having a mechanism for communication with the computing device 100. For example, the user terminal 200 may include a personal computer (PC), a laptop computer, a mobile terminal, a smartphone, a tablet PC, a wearable device, or the like, and may include all types of terminals capable of connecting to wired/wireless networks. In addition, the user terminal 200 may include any computing device implemented by at least one of an agent, an application programming interface (API), and a plug-in. In addition, the user terminal 200 may include an application source and/or a client application.

In addition, here, the network 400 may refer to a connection structure allowing information to be exchanged between each node, such as a plurality of terminals and servers. For example, the network 400 may include a local area network (LAN), a wide area network (WAN), the Internet (World Wide Web (WWW)), a wired and wireless data communication network, a telephone network, a wired and wireless television communication network, a controller area network (CAN), Ethernet, or the like.

The wireless data communication network may include 3G, 4G, 5G, 3rd generation partnership project (3GPP), 5th generation partnership project (5GPP), long term evolution (LTE), world interoperability for microwave access (WIMAX), Wi-Fi, Internet, a local area network (LAN), a wireless local area network (Wireless LAN), a wide area network (WAN), a personal area network (PAN), radio frequency (RF), a Bluetooth network, a near-field communication (NFC) network, a satellite broadcasting network, an analog broadcasting network, a digital multimedia broadcasting (DMB) network, and the like, but is not limited thereto.

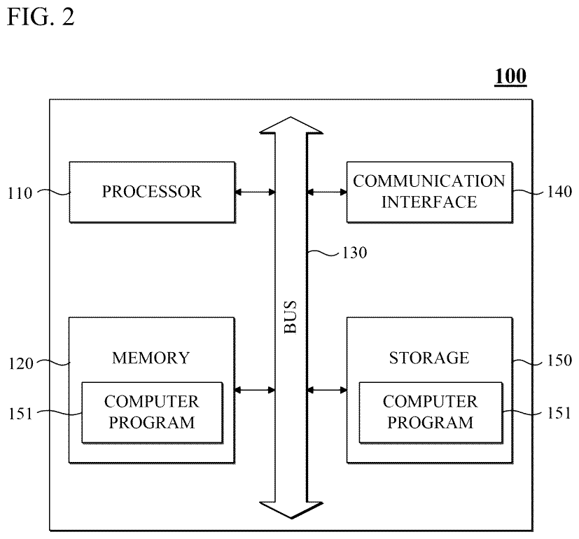

In one embodiment, the external server 300 may be connected to the computing device 100 via the network 400, and may store and manage various information and data required for the computing device 100 to perform a method of preventing a collision of an autonomous vehicle, or may collect, store, and manage various information and data derived as the computing device 100 performs the method of preventing a collision of an autonomous vehicle. For example, the external server 300 may be a storage server separately provided outside the computing device 100, but is not limited thereto. Hereinafter, with reference to FIG. 2, the hardware configuration of the computing device 100 that performs the method of preventing a collision of an autonomous vehicle will be described.

FIG. 2 is a hardware configuration diagram of a computing device that performs a collision prevention method of an autonomous vehicle according to another embodiment of the present invention.

Referring to FIG. 2, in various embodiments, a computing device 100 may include one or more processors 110, a memory 120 for loading a computer program 151 performed by the processor 110, a bus 130, a communication interface 140, and a storage 150 for storing the computer program 151. Here, only components related to embodiments of the present invention are illustrated in FIG. 2. Accordingly, those of ordinary skill in the art to which the present invention pertains may see that general-purpose components other than those illustrated in FIG. 2 may be further included.

The processor 110 controls the overall operation of each component of the computing device 100. The processor 110 may include a central processing unit (CPU), a micro processor unit (MPU), a micro controller unit (MCU), a graphics processing unit (GPU), or any type of processor well known in the art of the present invention.

In addition, the processor 110 may perform operations on at least one application or program for executing the method according to embodiments of the present invention, and the computing device 100 may include one or more processors.

In various embodiments, the processor 110 may further include a random access memory (RAM) (not illustrated) and a read only memory (ROM) (not illustrated) that temporarily and/or permanently store signals (or data) processed within the processor 110. In addition, the processor 110 may be implemented in the form of a system on chip (SoC) including at least one of the graphics processing unit, the RAM, and the ROM.

The memory 120 stores various data, commands and/or information. The memory 120 may be loaded with the computer program 151 from the storage 150 to execute the methods/operations according to various embodiments of the present invention. When the computer program 151 is loaded into the memory 120, the processor 110 may perform the methods/operations by executing one or more instructions constituting the computer program 151. The memory 120 may be implemented as a volatile memory such as a RAM, but the technical scope of the present disclosure is not limited thereto.

The bus 130 provides communication functions between components of the computing device 100. The bus 130 may be implemented as various types of buses, such as an address bus, a data bus, a control bus, and the like.

The communication interface 140 supports wired and wireless Internet communication of the computing device 100. In addition, the communication interface 140 may support various communication methods other than Internet communication. To this end, the communication interface 140 may include a communication module well known in the technical field of the present invention. In some embodiments, the communication interface 140 may be omitted.

The storage 150 may non-temporarily store the computer program 151. When performing a process of preventing a collision of an autonomous vehicle through the computing device 100, the storage 150 may store various information necessary to provide the process of preventing a collision of an autonomous vehicle.

The storage 150 may include a non-volatile memory such as a read only memory (ROM), an erasable programmable ROM (EPROM), an electrically erasable programmable ROM (EEPROM) a flash memory, or the like, a hard disk, a removable disk, or any form of computer-readable recording medium well known in the art to which the present invention pertains.

The computer program 151, when loaded into the memory 120, may include one or more instructions that cause the processor 110 to perform the methods/operations according to various embodiments of the present invention. That is, the processor 110 may perform the methods/operations according to various embodiments of the present invention by executing the one or more instructions.

In one embodiment, the computer program 151 may include one or more instructions for performing a method of preventing a collision of an autonomous vehicle, including selecting a collision detection target from among a plurality of road users positioned near the autonomous vehicle and determining a collision possibility between the autonomous vehicle and the selected collision detection target.

Steps of the method or algorithm described in relation to embodiments of the present invention may be implemented directly in hardware, implemented as a software module executed by hardware, or a combination thereof. The software module may reside on a random access memory (RAM), a read only memory (ROM), an erasable programmable ROM (EPROM), an electrically erasable programmable ROM (EEPROM), a flash memory, a hard disk, a removable disk, a CD-ROM, or any form of computer-readable recording medium well known in the art to which the present invention pertains.

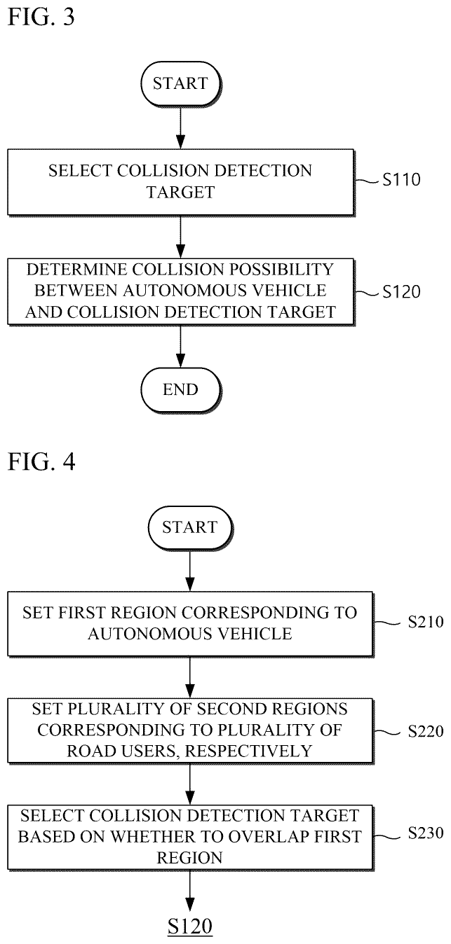

Components of the present invention may be implemented as a program (or application) and stored in a medium to be executed in conjunction with a computer, which is hardware. Components of the present invention may be executed by software programming or software elements, and similarly, embodiments may be implemented in a programming or scripting language such as C, C++, Java, assembler, or the like, including various algorithms implemented as combinations of data structures, processes, routines or other programming constructs. Functional aspects may be implemented as algorithms executed on one or more processors. Hereinafter, with reference to FIGS. 3 to 16, a method of preventing a collision of an autonomous vehicle performed by the computing device 100 will be described.

FIG. 3 is a flowchart of a method of preventing a collision of an autonomous vehicle according to still another embodiment of the present invention.

Referring to FIG. 3, in operation S110, the computing device 100 may select a collision detection target from among a plurality of road users positioned near the autonomous vehicle. To this end, the computing device 100 may perform an operation of detecting a road user positioned around the autonomous vehicle 10 in advance as the computing device performs a cognitive operation, but is not limited thereto, and in some cases, data derived by performing the cognitive operation by an external computing device (e.g., data resulting from detecting a road user positioned around the autonomous vehicle 10) may be acquired, and the collision detection target may be selected from among a plurality of road users positioned near the autonomous vehicle based on the acquired data.

In various embodiments, the computing device 100 may select a road user of concern as the collision detection target from among a plurality of road users positioned near the autonomous vehicle 10.

Meanwhile, when there are a small number of road users near the autonomous vehicle 10, the computing device 100 may require more resources to perform the operation of selecting the road user of concern from among the small number of road users as the collision detection target and the operation of determining the collision possibility between the collision detection target and the autonomous vehicle 10 compared to an operation of determining the collision possibility with the autonomous vehicle 10 for all road users.

Taking the point into consideration, the computing device 100 may perform the operation of determining the collision possibility for all road users when there are less than a preset number of road users near the autonomous vehicle 10 and perform the operation of selecting the collision detection target only when there are the preset number of road users or more near the autonomous vehicle 10, but is not limited thereto. Hereinafter, with reference to FIGS. 4 to 8, a method of selecting a collision detection target that is performed by the computing device 100 will be described in more detail.

FIG. 4 is a flowchart for describing a method of selecting a collision detection target in various embodiments.

Referring to FIG. 4, in operation S210, the computing device 100 may set a first region corresponding to the autonomous vehicle 10.

In various embodiments, the computing device 100 may set the first region corresponding to the autonomous vehicle 10 based on a driving route of the autonomous vehicle 10.

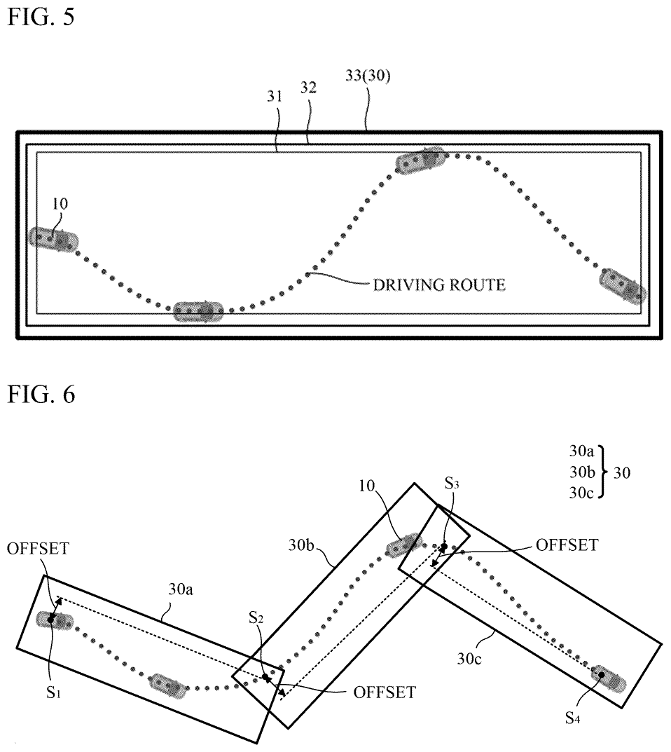

Here, the driving route of the autonomous vehicle 10 is a route for controlling the driving of the autonomous vehicle 10, and may be expressed as a set of a plurality of points disposed at equal intervals on the route, as illustrated in FIG. 5.

More specifically, referring to FIG. 5, first, the computing device 100 may set a first temporary region 31 that includes all of a plurality of points disposed on the driving route of the autonomous vehicle 10. Here, the first temporary region 31 may be set in a rectangular box shape and set to include all of the plurality of points, but may be set to have a minimum area, but is not limited thereto.

Then, the computing device 100 may set a second temporary region 32 by adjusting the size of the first temporary region 31 so that the entire shape area of the autonomous vehicle 10 is included when the autonomous vehicle 10 is positioned at a point corresponding to each of the plurality of points.

Then, the computing device 100 may set a third temporary region 33 by increasing the size of the second temporary region 32 at a predetermined ratio. For example, the computing device 100 may set the third temporary region 33 by reflecting a margin of a predetermined size in the second temporary region 32 to more reliably prevent a collision between autonomous vehicles 10 and a road user. However, the third temporary region is not limited thereto.

Then, the computing device 100 may set the third temporary region 33 as a first region 30 corresponding to the autonomous vehicle 10. However, the first region is not limited thereto.

Meanwhile, when the driving route of the autonomous vehicle 10 is a route for driving on a curved road, when the first region is set to include all points disposed on the driving route, there is a problem that the size of the first region becomes too large and thus road users with no collision possibility are not filtered out.

Taking the point into consideration, the computing device 100 may divide the driving route of the autonomous vehicle 10 according to a certain criterion and individually set the first region for each divided driving route.

More specifically, first, the computing device 100 may generate a plurality of point groups by classifying a plurality of points according to a preset criterion.

For example, referring to FIG. 6, when an offset between a first point S₁ and a second point S₂ after the first point S₁ among a plurality of points is equal to or greater than a threshold value, the computing device 100 may group points disposed between the first point S₁ and the second point S₂ into one first point group that is the same as the first point S₁.

In addition, when an offset between the second point S₂ and a third point S₃ after the second point S₂ is equal to or greater than a threshold value, the computing device 100 may group points disposed between the second point S₂ and the third point S₃ into one second point group that is the same as the second point S₂.

In addition, when an offset between the third point S₃ and a fourth point S₄ after the third point S₃ is equal to or greater than a threshold value, the computing device 100 may group points disposed between the third point S₃ and the fourth point S₄ into one third point group that is the same as the third point S₃.

Here, the offset may be a deviation to the left or right based on a driving direction of the autonomous vehicle 10, and in one embodiment, the threshold value of the offset may be set based on the width of a road on which the autonomous vehicle 10 is traveling. For example, the threshold value of the offset may be set to 3 m based on the width of the road, but is not limited thereto. In addition, the threshold value of the offset may be a fixed value, but is not limited thereto, and the threshold value of the offset may also be flexibly changed in response to changes in the width of the road.

Then, the computing device 100 may set a plurality of first unit regions corresponding to the plurality of point groups, respectively. For example, the computing device 100 may set a 1-1 unit region 30a using points included in the first point group, may set a 1-2 unit region 30b using points included in the second point group, and may set a 1-3 unit region 30c using points included in the third point group.

Then, the computing device 100 may set the first region including a plurality of first unit regions. For example, the computing device 100 may set the first region 30 including the 1-1 unit region 30a, the 1-2 unit region 30b, and the 1-3 unit region 30c, but is not limited thereto.

In operation S220, the computing device 100 may set a second region corresponding to each of the plurality of road users.

In various embodiments, the computing device 100 may set a plurality of second regions corresponding to the plurality of road users, respectively, based on an expected driving route for each of the plurality of road users.

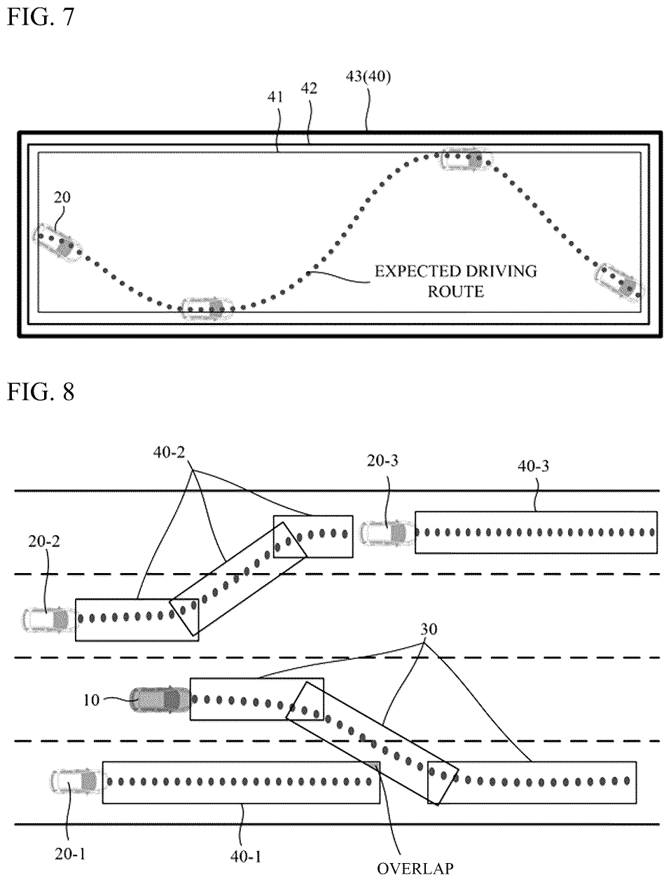

Here, the expected driving route for each of the plurality of road users is a route through which each of the plurality of road users is expected to travel for a predetermined period of time in the future, and may be expressed as a set of a plurality of points disposed at equal intervals on the expected driving route as illustrated in FIG. 7, but is not limited thereto.

Here, since the expected driving route for each of the plurality of road users and the driving route of the autonomous vehicle 10 have similar forms, a method of setting the second region for each of the plurality of road users may be implemented in a form identical or similar to a method of setting the first region corresponding to the autonomous vehicle 10, but is not limited thereto.

For example, as illustrated in FIG. 7, the computing device 100 may set a first temporary region 41 in a box shape including all of the plurality of points disposed on the expected driving route for one of the plurality of road users 20, set a second temporary region 42 by adjusting a size of the first temporary region 41 so that an entire shape area of the one of the road users is included when the one of the road users is positioned at a point corresponding to each of the plurality of points, and set a third temporary region 43 by increasing the size of the second temporary region 42 at a predetermined ratio and set the third temporary region 43 as a second region 40 corresponding to the one of the road users.

In addition, the computing device 100 may generate a plurality of point groups by classifying the plurality of points disposed on the expected driving route for the one road user according to a preset criterion, set a plurality of second unit regions corresponding to the plurality of point groups, respectively, and set the second region 40 including the plurality of second unit regions. However, the plurality of point groups are not limited thereto.

In operation S230, the computing device 100 may select the collision detection target from among a plurality of road users using the first region 30 set through operation S210 and the plurality of second regions 40 set through operation S220.

In various embodiments, the computing device 100 may select a second region 40 that at least partially overlaps the first region 30 from among the plurality of second regions 40, and select a road user corresponding to the second region 40 that overlaps the first region 30 as the collision detection target. For example, as illustrated in FIG. 8, when a first road user 20-1, a second road user 20-2, and a third road user 20-3 exist near the autonomous vehicle 10, and a second region 40-1 corresponding to the first road user 20-1 among the first road user 20-1, the second road user 20-2, and the third road user 20-3 at least partially overlaps the first region 30 corresponding to the autonomous vehicle 10, the computing device 100 may select the first road user 20-1 as the collision detection target. However, the collision detection target is not limited thereto.

Again, referring to FIG. 3, in operation S120, the computing device 100 may determine the collision possibility between the autonomous vehicle 10 and the collision detection target for the purpose of preventing the collision between the autonomous vehicle 10 and the collision detection target.

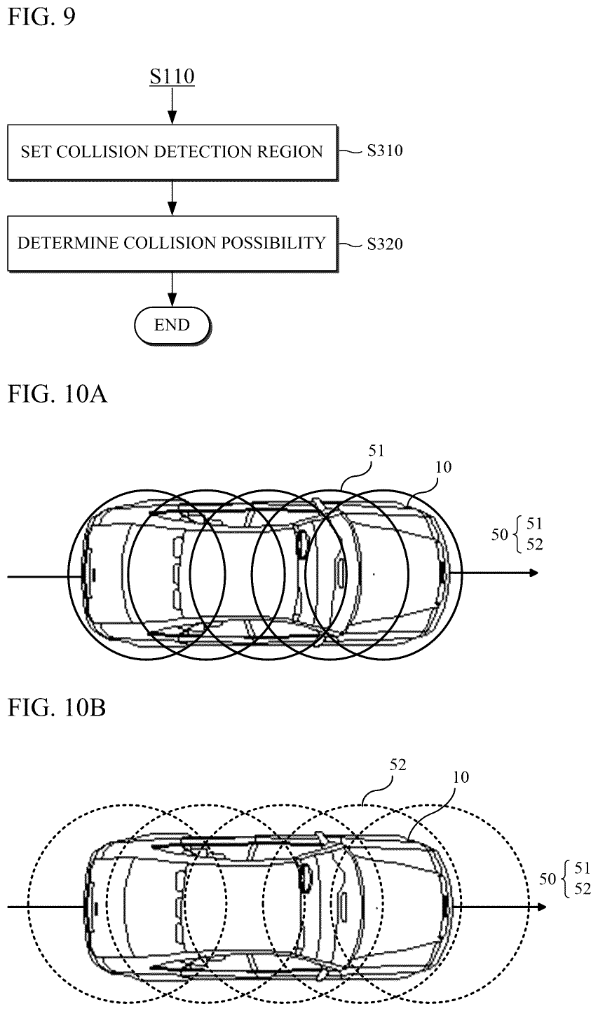

In various embodiments, the computing device 100 may set a collision detection region for each of the autonomous vehicle 10 and the road user 20 selected as the collision detection target based on states of the autonomous vehicle 10 and the road user 20 selected as the collision detection target and determine the collision possibility between the autonomous vehicle 10 and the road user 20 selected as the collision detection target using the collision detection region set for the autonomous vehicle 10 and the collision detection region for the road user 20 selected as the collision detection target. Hereinafter, descriptions will be given with reference to FIGS. 9 to 16.

FIG. 9 is a flowchart for describing a method of determining a collision possibility between an autonomous vehicle and a collision detection target in various embodiments.

Referring to FIG. 9, in operation S310, the computing device 100 may set a collision detection region for each of the autonomous vehicle 10 and a road user 20 selected as the collision detection target (hereinafter, referred to as a “collision detection target 20”).

In various embodiments, the computing device 100 may set the collision detection region by considering the states of the autonomous vehicle 10 and the collision detection target 20. For example, the computing device 100 may set the collision detection regions for the autonomous vehicle 10 and the collision detection target 20 by considering sizes, states (e.g., moving state or stationary state), moving speeds, and directions of the autonomous vehicle 10 and the collision detection target 20. Hereinafter, descriptions will be given with reference to FIGS. 10A to 14.

Here, only a method of setting the collision detection region of the autonomous vehicle 10 according to the state of the autonomous vehicle 10 is described with reference to FIGS. 10A to 14, but a method of setting the collision detection region of the collision detection target 20 according to the state of the collision detection target 20 may also be implemented in the same form as the method of setting the collision detection region of the autonomous vehicle 10.

First, referring to FIGS. 10A and 10B, in various embodiments, the computing device 100 may set a collision detection region 50 including a first collision detection region 51 and a second collision detection region 52 based on the state of the autonomous vehicle 10.

For example, as illustrated in FIG. 10A, the computing device 100 may set the first collision detection region 51 in a fixed shape with a predetermined size based on the size of the autonomous vehicle 10. Here, the predetermined size may refer to a size corresponding to a shape area of the autonomous vehicle 10.

In addition, as illustrated in FIG. 10B, the computing device 100 may set the second collision detection region 52 of a predetermined size based on the size of the autonomous vehicle 10. Here, based on the autonomous vehicle 10 being in the stationary state, the sizes of the first collision detection region 51 and the second collision detection region 52 may be set to the same size, but the sizes are not limited thereto, and based on the autonomous vehicle 10 being in the stationary state, the size of the second collision detection region 52 may be set to be larger than the size of the first collision detection region 51.

In various embodiments, the computing device 100 may set the first collision detection region 51 and the second collision detection region 52 in a form in which a plurality of circular detection regions overlap. However, without being limited thereto, the computing device 100 may apply various methods, such as a method of directly receiving input of the first collision detection region 51 and the second collision detection region 52 through a user interface (UI) provided to the user terminal 200.

In various embodiments, the computing device 100 may set a plurality of detection regions included in the first collision detection region 51 and the second collision detection region 52 using the following Equations 1 and 2.

First, the computing device 100 may calculate radii of the plurality of circular detection regions using the following Equation 1.

$${R}_{shape} = {w}_{shape} \sqrt{{l}_{r}^{2} + {( \frac{w}{2} )}^{2}} \qquad < Equation 1 >$$

Here, Rₛₕₐₚₑ may represent a radius value of a circular detection region, W shape may represent a weight value of a preset detection region, lᵣ may represent a distance value from the center of the rear wheel axle of the autonomous vehicle 10 to the rear of the autonomous vehicle 10, and w may represent a length of the autonomous vehicle 10 in a right-left direction.

In various embodiments, the computing device 100 may apply different weight values Wₛₕₐₚₑ to the first collision detection region 51 and the second collision detection region 52. For example, the computing device 100 may set the weight value Wₛₕₐₚₑ of the first collision detection region 51 to 0.7 and the weight value Wₛₕₐₚₑ of the second collision detection region 52 to 0.8, thereby allowing the second collision detection region 52 to be set to be greater than the first collision detection region 51. However, the sizes of the collision detection regions are not limited thereto.

Then, the computing device 100 may calculate an interval between the plurality of detection regions using the following Equation 2.

$${l}_{R} = \frac{{l}_{f} - {l}_{r}}{{n}_{shape} - 1} \qquad < Equation 2 >$$

Here, I_{R} may represent an interval between center points of the plurality of detection regions, lᵣ may represent the distance value from the center of the rear wheel axle of the autonomous vehicle 10 to the rear of the autonomous vehicle 10, l_{f} may represent a distance value from the center of the rear wheel axle of the autonomous vehicle 10 to the front of the autonomous vehicle 10, and nₛₕₐₚₑ may represent the number of the plurality of detection regions.

In various embodiments, the number of detection regions nₛₕₐₚₑ may be automatically generated based on the sizes of the autonomous vehicle 10 and the collision detection target 20, or may be input from the user terminal 200. However, the number of detection regions is not limited thereto.

In various embodiments, the computing device 100 may set the diameter value R shape of each of the plurality of detection regions included in the first collision detection region 51 and the plurality of detection regions included in the second collision detection region 52 to be smaller than or equal to the width of the road.

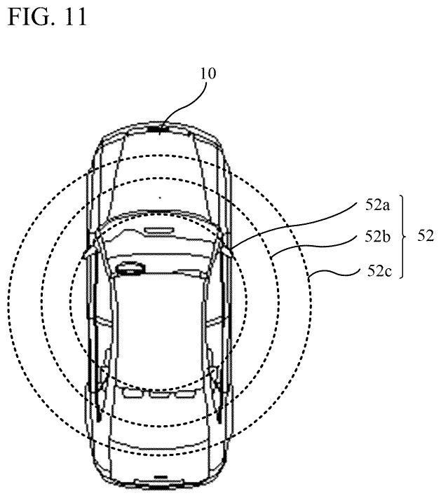

Next, referring to FIG. 11, in various embodiments, the computing device 100 may set a plurality of second collision detection regions 52a, 52b, and 52c having different sizes with respect to the autonomous vehicle 10.

Here, a criterion for determining the collision possibility may be differently set for each of the plurality of second collision detection regions 52a, 52b, and 52c, but is not limited thereto.

As one example, the computing device 100 may set the second collision detection region 52a for determining whether the autonomous vehicle overlaps the center line of the road or a guardrail, the second collision detection region 52b for determining whether the autonomous vehicle 10 and the collision detection target 20 overlap, and the second collision detection region 52c that is set to a widest range taking safety into consideration.

Here, even when a collision detection region set on the guardrail at least partially overlaps the second collision detection region 52c set to the widest range taking safety into consideration, the computing device 100 may determine the collision possibility between the autonomous vehicle 10 and the guardrail as safe when the collision detection region does not overlap the second collision detection region 52a for determining whether the autonomous vehicle overlaps the center line of the road or the guardrail. However, the determination is not limited thereto.

In various embodiments, the computing device 100 may express the plurality of second collision detection regions 52a, 52b, and 52c as a single parameter using a preset probability model (e.g., a Gaussian model) so that different levels of collision risk may be measured according to the distance from the center of the plurality of second collision detection regions 52a, 52b, and 52c.

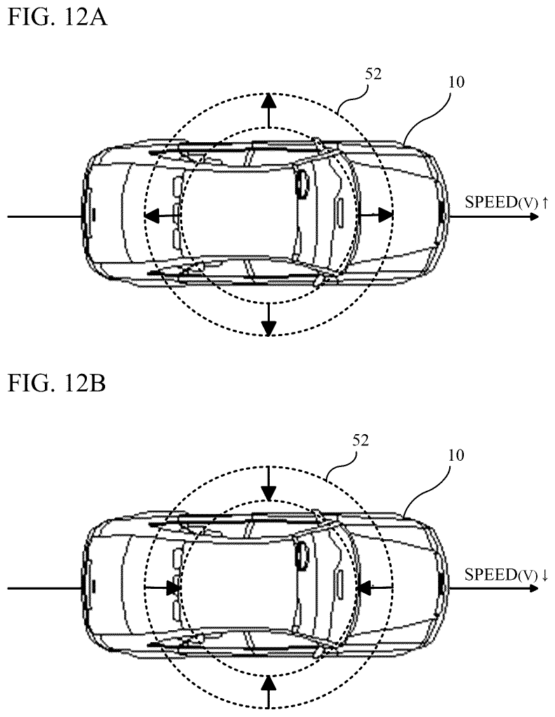

In various embodiments, the computing device 100 may change properties of each collision detection region 50 set for the autonomous vehicle 10 when the state of the autonomous vehicle 10 is changed. For example, the computing device 100 may change at least one of the size, interval, and number of detection regions included in the collision detection region 50 of the autonomous vehicle 10 in response to a change in the speed of the autonomous vehicle 10. Hereinafter, descriptions will be given with reference to FIGS. 12A to 14.

First, referring to FIGS. 12A and 12B, the computing device 100 may adjust the size of the second collision detection region 52 by changing the radius values of a plurality of detection regions included in the second collision detection region 52 of the autonomous vehicle 10 in response to the change in the speed of the autonomous vehicle 10.

For example, the computing device 100 may increase the size of the second collision detection region 52 in response to an increase in the speed of the autonomous vehicle 10, as illustrated in FIG. 12A. In addition, the computing device 100 may decrease the size of the second collision detection region 52 in response to a decrease in the speed of the autonomous vehicle 10, as illustrated in FIG. 12B.

In various embodiments, the computing device 100 may decrease the size of the second collision detection region 52 in response to the decrease in the speed of the autonomous vehicle 10, but set the size to be equal to the first collision detection region 51 or greater than the first collision detection region 51. However, the size is not limited thereto.

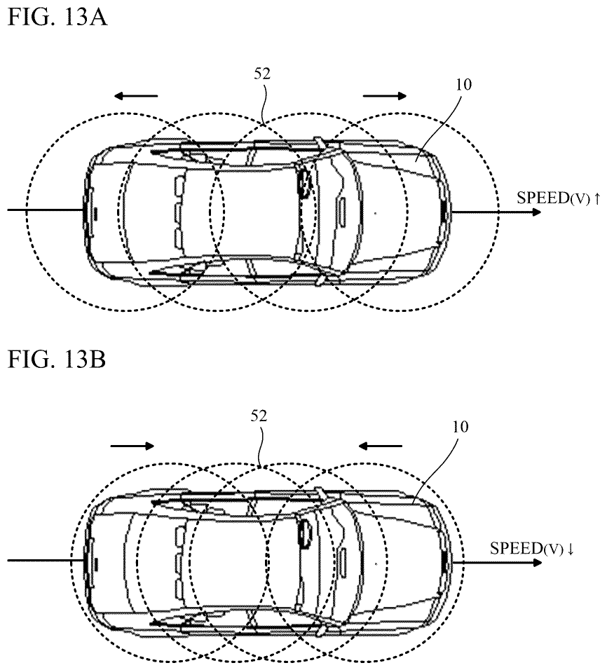

Next, referring to FIGS. 13A and 13B, the computing device 100 may change the interval between the plurality of detection regions included in the second collision detection region 52 in response to a change in the speed of the autonomous vehicle 10 and the collision detection target 20.

For example, the computing device 100 may increase the interval between the plurality of detection regions included in the second collision detection region 52 in response to an increase in the speed of the autonomous vehicle 10, as illustrated in FIG. 13A. In addition, the computing device 100 may decrease the interval between the plurality of detection regions included in the second collision detection region 52 in response to a decrease in the speed of the autonomous vehicle 10, as illustrated in FIG. 13B.

In various embodiments, the computing device 100 may decrease the interval between the plurality of detection regions included in the second collision detection region 52 in response to the decrease in the speed of the autonomous vehicle 10, but set the interval to be equal to or greater than the interval between the plurality of detection regions included in the second collision detection region 52. However, the interval is not limited thereto.

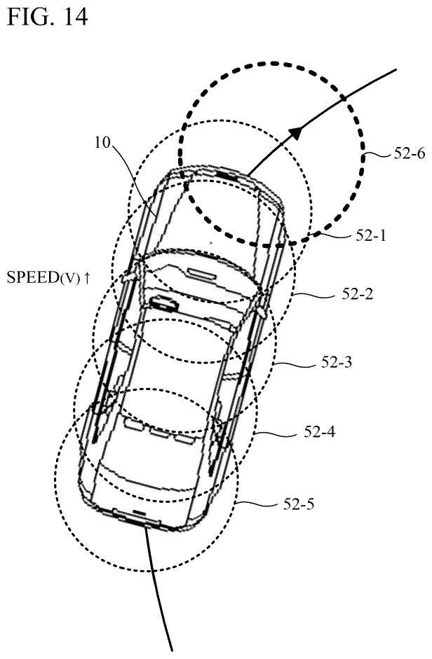

Next, referring to FIG. 14, the computing device 100 may change the number of the plurality of detection regions included in the second collision detection region 52 in response to a change in the speed of the autonomous vehicle 10.

In various embodiments, the computing device 100 may increase the number of at least one detection region included in the second collision detection region 52 in response to an increase in the speed of the autonomous vehicle 10.

More specifically, first, the computing device 100 may set the second collision detection region 52 including a first detection region 52-1, a second detection region 52-2, a third detection region 52-3, a fourth detection region 52-4, and a fifth detection region 52-5 based on a state in which the autonomous vehicle 10 is stopped.

Then, when the speed of the autonomous vehicle 10 increases in a state in which the autonomous vehicle 10 is moving forward, the computing device 100 may add a sixth detection region 52-6 that is a new detection region to the front of the second collision detection region 52 of the autonomous vehicle 10 (e.g., the front of the first detection region 52-1). Meanwhile, when the speed of the autonomous vehicle 10 increases in a state in which the autonomous vehicle 10 is moving backward, the computing device 100 may add the sixth detection region 52-6 that is the new detection region to the rear of the second collision detection region 52 of the autonomous vehicle 10 (e.g., the rear of the fifth detection region 52-5). However, the number is not limited thereto.

In various embodiments, the computing device 100 may add the sixth detection region 52-6 that is the new detection region to the front of the second collision detection region 52 in response to an increase in the speed of the autonomous vehicle 10, and when there is a driving route of the autonomous vehicle 10, the sixth detection region 52-6 may be disposed on the driving route of the autonomous vehicle 10. For example, when there is the driving route of the autonomous vehicle 10 and the driving route of the autonomous vehicle 10 is a right-turning route, the computing device 100 may dispose the sixth detection region 52-6 at a position biased to the right from the front of the autonomous vehicle 10.

In various embodiments, the computing device 100 may decrease the number of at least one detection region included in the second collision detection region 52 in response to a decrease in the speed of the autonomous vehicle 10. For example, the computing device 100 may decrease the number of at least one detection region included in the second collision detection region 52 in response to the decrease in the speed of the autonomous vehicle 10.

In various embodiments, the computing device 100 may decrease the number of at least one detection region included in the second collision detection region 52 in response to the decrease in the speed of the autonomous vehicle 10, but may preferentially delete the newly added detection region (e.g., the sixth detection region 52-6) as the speed of the autonomous vehicle 10 increases. However, the decrease of the number is not limited thereto.

In operation S320, the computing device 100 may determine the collision possibility between the autonomous vehicle 10 and the collision detection target 20 based on the collision detection region set through operation S310.

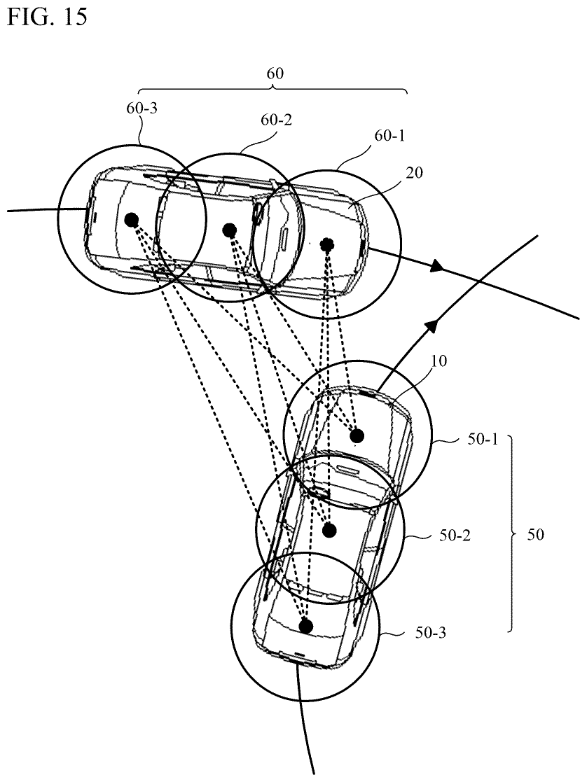

More specifically, referring to FIG. 15, the computing device 100 may determine the collision possibility by comparing a distance between a center point of each of a plurality of detection regions 50-1, 50-2, and 50-3 included in the collision detection region 50 of the autonomous vehicle 10 and a center point of each of a plurality of detection regions 60-1, 60-2, and 60-3 included in a collision detection region 60 of the collision detection target 20.

First, the computing device 100 may calculate the distance from the center point of the first detection region 50-1 of the autonomous vehicle 10 to the center point of each of the first detection region 60-1, the second detection region 60-2, and the third detection region 60-3 of the collision detection target 20. In addition, the computing device 100 may calculate the distance from the center point of the second detection region 50-2 of the autonomous vehicle 10 to the center point of each of the first detection region 60-1, the second detection region 60-2, and the third detection region 60-3 of the collision detection target 20. In addition, the computing device 100 may calculate the distance from the center point of the third detection region 50-3 of the autonomous vehicle 10 to the center point of each of the first detection region 60-1, the second detection region 60-2, and the third detection region 60-3 of the collision detection target 20.

Then, the computing device 100 may determine the collision possibility between the autonomous vehicle 10 and the collision detection target 20 by comparing the distance values (e.g., nine distance values) calculated by the method with a reference value.

Here, the reference value may refer to the sum of the radii of two detection regions (e.g., a specific detection region of the autonomous vehicle 10 and a specific detection region of the collision detection target 20) that are targets whose distance values are to be calculated. For example, when there is a distance value smaller than the sum of the radii of the plurality of detection regions 50-1, 50-2, and 50-3 included in the collision detection region 50 of the autonomous vehicle 10 and the radii of the plurality of detection regions 60-1, 60-2, and 60-3 included in the collision detection region 60 of the collision detection target 20 among the nine distance values calculated by the method, the computing device 100 may determine that the autonomous vehicle 10 and the collision detection target 20 are in a collision state.

In various embodiments, the computing device 100 may determine the collision possibility between the autonomous vehicle 10 and the collision detection target 20 based on the size of the overlapping region between the collision detection region 50 set for the autonomous vehicle 10 and the collision detection region 60 set for the collision detection target 20.

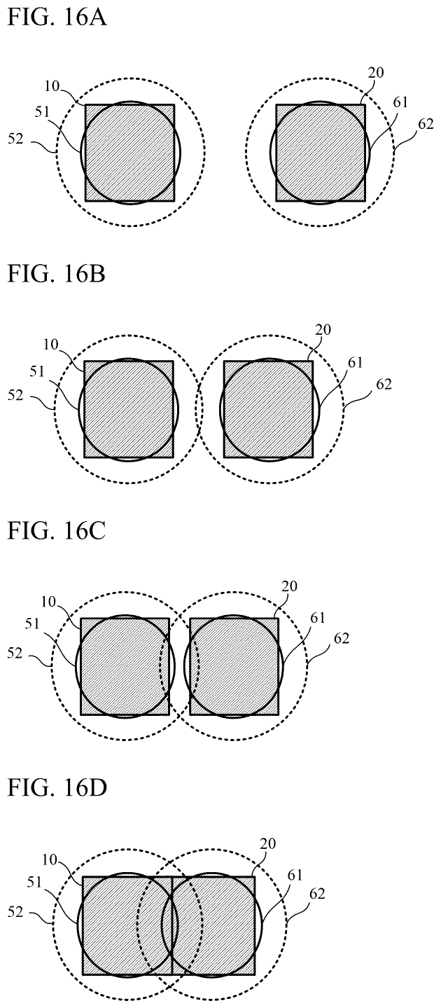

More specifically, first, as illustrated FIG. 16A, when the first collision detection region 51 and the second collision detection region 52 of the autonomous vehicle 10 and a first collision detection region 61 and a second collision detection region 62 of the collision detection target 20 do not overlap at all, the computing device 100 may determine that the autonomous vehicle 10 and the collision detection target 20 are in a safe state.

Next, as illustrated in FIG. 16B, when the second collision detection region 52 of the autonomous vehicle 10 and the second collision detection region 62 of the collision detection target 20 overlap, the computing device 100 may determine that the autonomous vehicle 10 and the collision detection target 20 are in a collision caution state.

Next, as illustrated in FIG. 16C, when the second collision detection region 52 of the autonomous vehicle 10 and the first collision detection region 61 of the collision detection target 20 or the first collision detection region 51 of the autonomous vehicle 10 and the second collision detection region 62 of the collision detection target 20 overlap, the computing device 100 may determine that the autonomous vehicle 10 and the collision detection target 20 are in a collision risk state.

Finally, as illustrated in FIG. 16D, when the first collision detection region 51 of the autonomous vehicle 10 and the first collision detection region 61 of the collision detection target 20 overlap, the computing device 100 may determine that the autonomous vehicle 10 and the collision detection target 20 are in a collision state. However, the decrease of the number is not limited thereto.

In various embodiments, the computing device 100 may determine the collision possibility at a present point in time and the collision possibility at a future point in time for each of the autonomous vehicle 10 and the collision detection target 20.

Here, the future point in time may be determined based on the driving route and a speed profile of the autonomous vehicle 10 and the expected driving route and an expected speed profile of the collision detection target 20, but is not limited thereto.

The computing device 100 may effectively prevent the collision of the autonomous vehicle 10 by controlling the operation of the autonomous vehicle 10 based on the collision possibility of the autonomous vehicle 10 derived according to the method described above.

The method of preventing a collision of an autonomous vehicle described above has been described with reference to the flowchart illustrated in the drawing. For simple description, the method of preventing a collision of an autonomous vehicle has been illustrated and described as a series of blocks, but the present invention is not limited to the order of the blocks, and some blocks may be performed simultaneously or in a different order than illustrated and described herein. In addition, new blocks not described in the specification and drawings may be added, or some blocks may be deleted or changed.

According to various embodiments of the present invention, by selecting road users of concern from among road users positioned near an autonomous vehicle and selectively determining the collision possibility only for the road users of concern, there are advantages that resources required for computational work to determine the collision possibility can be drastically reduced, a collision possibility determination operation can be more efficiently and quickly performed through the reduction, and a collision of the autonomous vehicle can be effectively prevented based on the effective and quick operation performance.

Effects of the present invention are not limited to those mentioned above, and other effects not mentioned will be clearly understood by those of ordinary skill in the art from the description below.

In the above, the embodiments of the present invention have been described with reference to the accompanying drawings, and those of ordinary skill in the art to which the present invention pertains could understand that the additional or alternative embodiments may be embodied in other specific forms without departing from the technical spirit or essential features of the present invention. Therefore, it should be appreciated that the embodiments described above are intended to be illustrative in all respects and not restrictive.

What is claimed is:

1. A method of preventing a collision of an autonomous vehicle performed by a computing device, comprising:
selecting a collision detection target from among a plurality of road users positioned near the autonomous vehicle; and
determining a collision possibility between the autonomous vehicle and the selected collision detection target.

2. The method of claim 1, wherein the selecting of the collision detection target includes:
setting a first region corresponding to the autonomous vehicle based on a driving route of the autonomous vehicle;
setting a plurality of second regions corresponding to the plurality of road users, respectively, based on an expected driving route for each of the plurality of road users; and
selecting a second region that at least partially overlaps the set first region from among the plurality of set second regions and selecting a road user corresponding to the selected second region as the collision detection target.

3. The method of claim 2, wherein the driving route of the autonomous vehicle is a route for controlling driving of the autonomous vehicle for a predetermined period of time and includes a plurality of points disposed at equal intervals on the route, and
the setting of the first region includes:
setting a first temporary region in a box shape including all of the plurality of points;
setting a second temporary region by adjusting a size of the set first temporary region so that an entire shape area of the autonomous vehicle is included when the autonomous vehicle is positioned at a point corresponding to each of the plurality of points; and
setting a third temporary region by increasing a size of the set second temporary region by a predetermined ratio and setting the set third temporary region as the first region corresponding to the autonomous vehicle.

4. The method of claim 2, wherein the driving route of the autonomous vehicle is a route for controlling driving of the autonomous vehicle for a predetermined period of time in the future and expressed as a set of a plurality of points disposed at equal intervals on the route, and
the setting of the first region includes:
generating a plurality of point groups by classifying the plurality of points according to a preset criterion;
setting a plurality of first unit regions corresponding to the plurality of generated point groups, respectively; and
setting a first region including the plurality of set first unit regions.

5. The method of claim 4, wherein the generating of the plurality of point groups includes:
grouping points disposed between a first point and a second point after the first point among the plurality of points into one point group that is the same as the first point when an offset between the first point and the second point is equal to or greater than a threshold value, wherein the offset is a deviation to the left or right based on a driving direction of the autonomous vehicle; and
grouping points disposed between the second point and a third point after the second point into one point group that is the same as the second point when an offset between the second point and the third point is equal to or greater than the threshold value.

6. The method of claim 2, wherein the expected driving route for each of the plurality of road users is a route through which each of the plurality of road users is expected to travel for a predetermined period of time in the future and expressed as a set of a plurality of points disposed at equal intervals on the expected route, and
the setting of the plurality of second regions includes:
setting a first temporary region in a box shape including all of the plurality of points disposed on the expected driving route for one of the plurality of road users;
setting a second temporary region by adjusting a size of the set first temporary region so that an entire shape area of the one of the road users is included when the one of the road users is positioned at a point corresponding to each of the plurality of points; and
setting a third temporary region by increasing a size of the set second temporary region at a predetermined ratio and setting the set third temporary region as the second region corresponding to the one of the road users.

7. The method of claim 2, wherein the expected driving route for each of the plurality of road users is a route through which each of the plurality of road users is expected to travel for a predetermined period of time in the future and expressed as a set of a plurality of points disposed at equal intervals on the expected route, and
the setting of the plurality of second regions includes:
generating a plurality of point groups by classifying a plurality of points disposed on the expected driving route for one of the plurality of road users according to a preset criterion;
setting a plurality of second unit regions corresponding to the plurality of generated point groups, respectively; and
setting the second region including the plurality of set second unit regions.

8. The method of claim 1, wherein the determining of the collision possibility includes:
setting a collision detection region for each of the autonomous vehicle and the selected collision detection target based on states of the autonomous vehicle and the selected collision detection target; and
determining the collision possibility between the autonomous vehicle and the selected collision detection target using the collision detection region set for the autonomous vehicle and the collision detection region set for the selected collision detection target, and
the collision detection region set for each of the autonomous vehicle and the selected collision detection target includes a first collision detection region and a second collision detection region, and is expressed as a set of a plurality of circular regions.

9. The method of claim 1, wherein the determining of the collision possibility includes determining a collision possibility at a present point in time and a collision possibility at a future point in time for each of the autonomous vehicle and the selected collision detection target, wherein the future point in time is determined based on a driving route and a speed profile of the autonomous vehicle and an expected driving route and an expected speed profile of the selected collision detection target.

10. A computing device that performs a method of preventing a collision of an autonomous vehicle, comprising:
a processor;
a network interface;
a memory; and
a computer program that is loaded into the memory and is executed by the processor, wherein the computer program includes:
instructions for selecting a collision detection target from among a plurality of road users positioned near the autonomous vehicle; and
instructions for determining a collision possibility between the autonomous vehicle and the selected collision detection target.

11. A computer readable recording medium that is coupled to a computing device and has a program for executing a method of preventing a collision of an autonomous vehicle recorded thereon, the method comprising:
selecting a collision detection target from among a plurality of road users positioned near the autonomous vehicle; and
determining a collision possibility between the autonomous vehicle and the selected collision detection target.
